(19) United States
(12) Patent Application Publication
(10) Pub. No.: US 2026/0077817 A1
(43) Pub. Date: Mar. 19, 2026

(54) VEHICLE CLOSURE MODULE HANDLE ALIGNMENT SYSTEM

(71) Applicant: FORD GLOBAL TECHNOLOGIES, LLC, Dearborn, MI (US)

(72) Inventors: Alfonso Hickman Guevara, Tlalnepantla (MX); Jorge Cruz, San Mateo (MX); Ulises Mauricio Gomez Sanchez, Ciudad de Mexico (MX); Lorena Virginia Mendez, CDMX, Azcapotzalco (MX); Maria del Rocio Baltazar Real, CUAUTITLAN IZCALLI (MX)

(21) Appl. No.: 18/884,878

(22) Filed: Sep. 13, 2024

(51) Int. Cl. B62D 25/12; B62D 25/08; B62D 25/10; E05B 1/00

(52) U.S. Cl. CPC B62D 25/12; E05B 1/0015; B62D 25/082; B62D 25/105

(57) ABSTRACT

A device may include a closure module of a vehicle, the closure module pivotable back and forth between a closed position and an open position. A device may include a body structure of the vehicle disposed beneath the closure module, the body structure including a pocket. A device may include a handle suspended from the closure module. A device may include a retractable line extending though the pocket to the handle, the retractable line configured to retract when the closure module is pivoted from the open position to the closed position to draw the handle into the pocket of the body structure.

### TECHNICAL FIELD

This disclosure relates generally to closure modules of vehicles that have a handle and, more particularly, to an alignment system for such a handle.

### BACKGROUND

Vehicle closure modules pivot or otherwise move back and forth between a closed position and an open position. Some closure modules include handles that a user can grasp when pivoting the closure module.

### SUMMARY

In some aspects, the techniques described herein relate to a vehicle assembly, including: a closure module of a vehicle, the closure module pivotable back and forth between a closed position and an open position; a body structure of the vehicle disposed beneath the closure module, the body structure including a pocket; a handle suspended from the closure module; and a retractable line extending though the pocket to the handle, the retractable line configured to retract when the closure module is pivoted from the open position to the closed position to draw the handle into the pocket of the body structure.

In some aspects, the techniques described herein relate to a vehicle assembly, further including a retraction mechanism operably coupled to the retractable line, the retraction mechanism configured to retract the retractable line.

In some aspects, the techniques described herein relate to a vehicle assembly, wherein the retraction mechanism is at least partially disposed within the pocket.

In some aspects, the techniques described herein relate to a vehicle assembly, wherein, when the closure module is pivoted from the closed position to the open position, the handle pulls the retractable line toward an extended position away from the retraction mechanism.

In some aspects, the techniques described herein relate to a vehicle assembly, wherein the retraction mechanism biases the retractable line toward a retracted position within the retraction mechanism.

In some aspects, the techniques described herein relate to a vehicle assembly, wherein a biasing force applied to the retractable line by the retraction mechanism is maintained as the closure module is pivoted between the closed position and the open position.

In some aspects, the techniques described herein relate to a vehicle assembly, wherein the retractable line is removably coupled to the handle.

In some aspects, the techniques described herein relate to a vehicle assembly, wherein the retractable line includes a stop member configured to block the retractable line from fully retracting into the retraction mechanism when the retractable line is not coupled to the handle.

In some aspects, the techniques described herein relate to a vehicle assembly, wherein the stop member is a button, and the handle includes a socket that is couplable to the button.

In some aspects, the techniques described herein relate to a vehicle assembly, wherein, when the closure module is in the closed position, the handle is received within the pocket.

In some aspects, the techniques described herein relate to a vehicle assembly, wherein, when the closure module is pivoted from the closed position to the open position, the closure module draws the handle out of the pocket.

In some aspects, the techniques described herein relate to a vehicle assembly, wherein the handle is a flexible strap.

In some aspects, the techniques described herein relate to a vehicle assembly, wherein the closure module is a hood.

In some aspects, the techniques described herein relate to a vehicle assembly, wherein the body structure is an engine bay structure.

In some aspects, the techniques described herein relate to a vehicle closure alignment method, including: guiding a handle when pivoting a closure module of a vehicle from an open position to a closed position, the handle hanging from the closure module.

In some aspects, the techniques described herein relate to a method, wherein guiding the handle pulls the handle into a pocket of a body structure of the vehicle.

In some aspects, the techniques described herein relate to a method, further including retracting a line during the guiding, the line extending from the body structure to the handle.

In some aspects, the techniques described herein relate to a method, wherein retracting the line draws the handle into the pocket when the closure module is pivoted from the open position to the closed position.

In some aspects, the techniques described herein relate to a method, further including pivoting the closure module to the open position after the guiding, wherein the pivoting draws the handle out of the pocket.

In some aspects, the techniques described herein relate to a method, wherein, when the closure module is pivoted from the closed position to the open position, the line moves from a retracted position to an extended position.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a vehicle including a closure module in a closed position.

FIG. 2 illustrates the vehicle of FIG. 1 with the closure module in an open position relative to a body structure of the vehicle and showing a handle and retractable line according to an exemplary aspect of the present disclosure.

FIG. 3 illustrates a perspective view of the closure module and the body structure of FIG. 2 with a handle operably coupled to a retraction mechanism through a retractable line.

FIG. 4 illustrates a close-up perspective view of the handle and retractable line of FIG. 3.

FIG. 5 illustrates the close-up perspective view from FIG. 4 but with the handle decoupled from the retractable line.

### DETAILED DESCRIPTION

This disclosure relates generally to a handle that a user can grasp to assist the user when pivoting a closure module, such as a vehicle hood, from an open position to a closed position. In an example, a retractable line can be coupled to the handle. The retractable line draws the handle into a pocket of a body structure of a vehicle as the closure module is pivoted from the open position to the closed position. These and other features are discussed in greater detail in the following paragraphs of this detailed description.

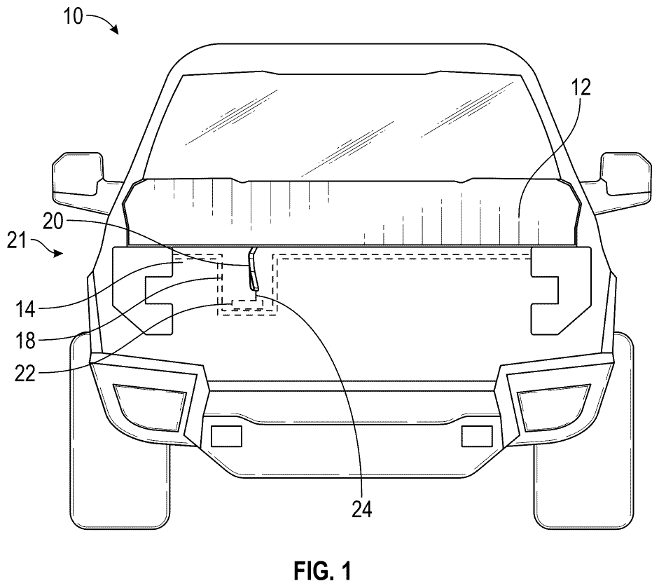

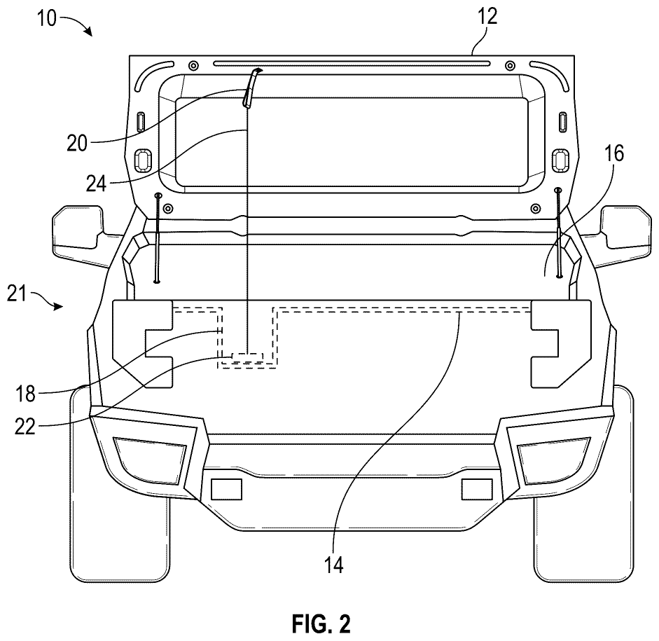

FIGS. 1 and 2 illustrate a vehicle 10. Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the exemplary embodiment, the vehicle 10 is a pickup truck. However, the vehicle 10 could alternatively be a car, van, sports utility vehicle (SUV), or any other vehicle configuration.

The vehicle 10 includes a closure module 12 and a body structure 14. The closure module 12 is a hood in this example. In another example, the closure module 12 could be a trunk lid or any other type of closure module.

The closure module 12 can pivot or otherwise move back and forth between a closed position (FIG. 1) and an open position (FIG. 2). When in the closed position, the closure module 12 covers a compartment 16 (e.g., engine compartment or frunk) of the vehicle 10. When in the open position, the closure module 12 permits users to access the compartment 16 of the vehicle 10.

The body structure 14 is disposed beneath the closure module 12 and includes a pocket 18. The pocket 18 opens upward toward the closure module 12 in this example. In this example, the body structure 14 is an engine bay cover. The body structure 14 can enhance the aesthetic appearance of the engine bay by covering or otherwise concealing parts of the engine and other mechanical components.

A handle 20 is coupled to the closure module 12. A user can grasp and pull the handle 20 to pivot the closure module 12 from the closed position.

An alignment system 21 is provided to guide or otherwise draw the handle 20 into the pocket 18 of the body structure 14 when the closure module 12 is pivoted to the closed position. The alignment system 21 includes a retraction mechanism 22 and a retractable line 24, such as a retractable cable, that is operably coupled to the handle 20 and the retraction mechanism 22.

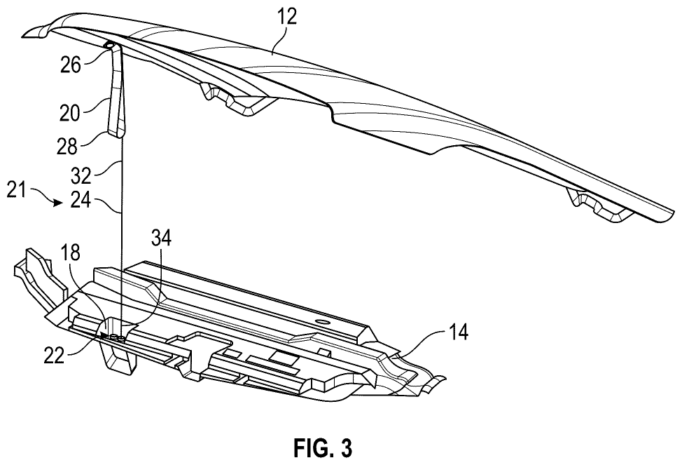

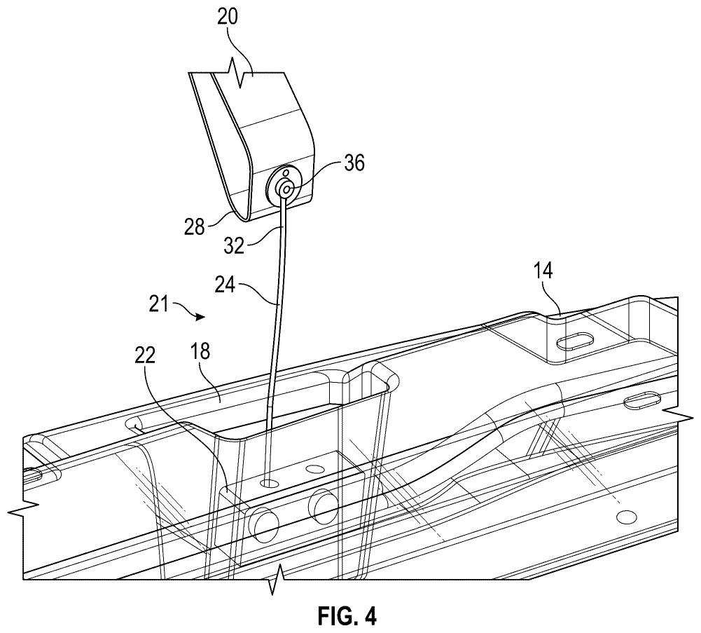

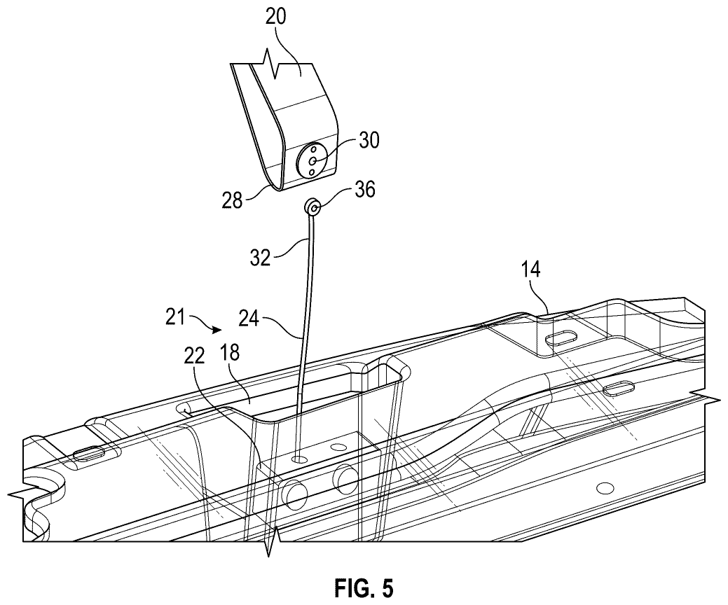

Referring now to FIGS. 3-5, with continued reference to FIGS. 1 and 2, a first end 26 of the handle 20 is suspended from or otherwise hangs from the closure module 12. An opposite, second end 28 of the handle 20 is removably coupled to the retractable line 24. In this example, a socket 30 is provided on the second end 28 to couple the handle 20 to the retractable line 24 (see FIG. 5). In another example, the retractable line 24 could be coupled to the handle 20 by another mechanism that allows for quick and secure attachment and detachment of the handle 20 with respect to the retractable line 24.

The handle 20 is configured to be grasped and pulled by a user to pivot the closure module 12 to the closed position. In this example, the handle 20 is a flexible strap.

The retraction mechanism 22 is supported on the body structure 14 of the vehicle 10. In this example, the retraction mechanism 22 is at least partially disposed in the pocket 18 of the body structure 14. The pocket 18 at least partially covers or otherwise conceals the retraction mechanism 22.

The retraction mechanism 22 is configured to retract the retractable line 24. The retraction mechanism 22 can include an internal coiled spring that is operably coupled to the retractable line 24. The coiled spring biases the retractable line 24 by applying a constant force that pulls the retractable line 24 toward the retraction mechanism 22.

The retractable line 24 extends between a first end 32 that is coupled to the handle 20 and a second end 34 that is coupled to the retraction mechanism 22. A stop member 36 is provided on the first end 32. In this example, the stop member 36 is a button that is couplable to the socket 30 of the handle 20. In one example, the stop member 36 is a hook (e.g., slip hook, snap hook, swivel hook, etc.), and the socket 30 of the handle 20 is replaced by one or more openings for coupling the stop member 36 to the handle 20.

A user can decouple the retractable line 24 from the handle 20 by decoupling the stop member 36 from the socket 30. When the retractable line 24 is not coupled to the handle 20, the retraction mechanism 22 can draw the retractable line 24 into the retraction mechanism 22, which may be necessary to, for example, load a large item into the compartment 16 (see FIG. 2).

The stop member 36 is configured to block the retractable line 24 from fully retracting into the retraction mechanism 22 when the retractable line 24 is not coupled to the handle 20. In this example, the stop member 36 is wider than an opening of the retraction mechanism 22 that receives the retractable line 24.

The retractable line 24 is configured to draw the handle 20 into the pocket 18 of the body structure 14 when the closure module 12 is pivoted from the open position to the closed position. When the closure module 12 is in the open position, the handle 20 holds the retractable line 24 in an extended position. When the retractable line 24 is in the extended position, the first end 32 of the retractable line 24 is positioned away from the retraction mechanism 22 (see FIG. 2).

A user can grasp and pull the handle 20 to pivot the closure module 12 from the open position to the closed position. The pulling force initially provided by the user is sufficient to overcome the forces holding the closure module 12 in the open position so the closure module 12 can begin to move to the closed position. The user can release the handle 20 after the initial pull and allow gravitational forces and retraction mechanisms to continue pivoting the closure module 12 to the closed position. As the closure module 12 is pivoted from the open position to the closed position, the retraction mechanism 22 retracts the retractable line 24 into the pocket 18 of the body structure 14, which draws or otherwise guides the handle 20 toward the pocket 18. When the closure module 12 is in the closed position, the handle 20 is at least partially received in the pocket 18 (see FIG. 1).

When the closure module 12 is pivoted from the closed position to the open position, the closure module 12 pulls the handle 20 out of the pocket 18 of the body structure 14. The forces causing the closure module 12 to pivot to the open position can be provided by the user, lift assists, or some combination of these. The forces causing the closure module 12 to pivot to the open position also pull the handle 20 and withdraw the retractable line 24 out of the retraction mechanism 22. The internal coiled spring of the retraction mechanism 22 maintains a biasing force on the retractable line 24 as the retractable line 24 moves between the extended position and the retracted position. This ensures that the retractable line 24 can extend and retract smoothly as the closure module 12 is pivoted back and forth between the closed position and the open position.

Features of this disclosure include an alignment system that can guide a handle into a desired position when a hood, for example, is closed.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle assembly, comprising:
a closure module of a vehicle, the closure module pivotable back and forth between a closed position and an open position;
a body structure of the vehicle disposed beneath the closure module, the body structure including a pocket;
a handle suspended from the closure module; and
a retractable line extending though the pocket to the handle, the retractable line configured to retract when the closure module is pivoted from the open position to the closed position to draw the handle into the pocket of the body structure.

2. The vehicle assembly of claim 1, further comprising a retraction mechanism operably coupled to the retractable line, the retraction mechanism configured to retract the retractable line.

3. The vehicle assembly of claim 2, wherein the retraction mechanism is at least partially disposed within the pocket.

4. The vehicle assembly of claim 2, wherein, when the closure module is pivoted from the closed position to the open position, the handle pulls the retractable line toward an extended position away from the retraction mechanism.

5. The vehicle assembly of claim 2, wherein the retraction mechanism biases the retractable line toward a retracted position within the retraction mechanism.

6. The vehicle assembly of claim 5, wherein a biasing force applied to the retractable line by the retraction mechanism is maintained as the closure module is pivoted between the closed position and the open position.

7. The vehicle assembly of claim 2, wherein the retractable line is removably coupled to the handle.

8. The vehicle assembly of claim 7, wherein the retractable line includes a stop member configured to block the retractable line from fully retracting into the retraction mechanism when the retractable line is not coupled to the handle.

9. The vehicle assembly of claim 8, wherein the stop member is a button, and the handle includes a socket that is couplable to the button.

10. The vehicle assembly of claim 1, wherein, when the closure module is in the closed position, the handle is received within the pocket.

11. The vehicle assembly of claim 1, wherein, when the closure module is pivoted from the closed position to the open position, the closure module draws the handle out of the pocket.

12. The vehicle assembly of claim 1, wherein the handle is a flexible strap.

13. The vehicle assembly of claim 1, wherein the closure module is a hood.

14. The vehicle assembly of claim 1, wherein the body structure is an engine bay structure.

15. A vehicle closure alignment method, comprising:
guiding a handle when pivoting a closure module of a vehicle from an open position to a closed position, the handle hanging from the closure module.

16. The method of claim 15, wherein guiding the handle pulls the handle into a pocket of a body structure of the vehicle.

17. The method of claim 16, further comprising retracting a line during the guiding, the line extending from the body structure to the handle.

18. The method of claim 17, wherein retracting the line draws the handle into the pocket when the closure module is pivoted from the open position to the closed position.

19. The method of claim 17, further comprising pivoting the closure module to the open position after the guiding, wherein the pivoting draws the handle out of the pocket.

20. The method of claim 19, wherein, when the closure module is pivoted from the closed position to the open position, the line moves from a retracted position to an extended position.
